(19) United States
(12) Patent Application Publication
(10) Pub. No.: US 2026/0351132 A1
(43) Pub. Date: Nov. 5, 2026

(54) METHOD AND APPARATUS FOR GENERATING VIRTUAL SCENARIOS

(71) Applicants: Hyundai Motor Company, Seoul (KR); Kia Corporation, Seoul (KR)

(72) Inventor: Jinwoo KIM, Hwaseong-Si (KR)

(21) Appl. No.: 19/431,325

(22) Filed: Dec. 23, 2025

(30) Foreign Application Priority Data
May 2, 2025 (KR) 10-2025-0058011

(51) Int. Cl. G09B 9/048; G06T 13/20; G06T 17/00; G06T 19/20

(52) U.S. Cl. CPC G09B 9/048; G06T 13/20; G06T 17/00; G06T 19/20; G06T 2219/2004

(57) ABSTRACT

A method and apparatus for generating a virtual scenario are provided. The method may include determining a virtual object participating in an event of a virtual scenario in a vehicle driving simulation for verifying a vehicle function; determining a trigger condition for synchronizing an action of the virtual object; identifying a state of the virtual object to determine a state-specific action for the state; identifying characteristics of a road environment and a road environment-related object; obtaining a trained road network model that comprises the road environment and the road environment-related object; creating a virtual scenario file describing the virtual scenario according to a predetermined schema associated with the virtual scenario; and causing, based on the virtual scenario file, an update of at least one of the vehicle driving simulation or autonomous driving of the at least one vehicle.

### CROSS-REFERENCE TO RELATED APPLICATION

This application claims priority to and the benefit of Korean Patent Application No. 10-2025-0058011 filed with the Korean Intellectual Property Office on May 2, 2025, the entire contents of which are incorporated herein by reference.

### TECHNICAL FIELD

The disclosure relates to a method and apparatus for generating a virtual scenario.

### BACKGROUND

In development of autonomous driving technologies, including advanced driver assistance systems (ADAS), it may be very helpful to create virtual scenarios that reflect various real-life traffic situations and environmental conditions for testing and verification purposes. Accordingly, many virtual scenarios are being created and stored using the OpenSCENARIO standard, which is an Extensible Markup Language (XML)-based format developed by the Association for Standardization of Automation and Measuring Systems (ASAM). However, the ASAM OpenSCENARIO standard does not provide specific guidance on how to describe the virtual scenarios structurally. Thus, virtual scenarios with different configurations may be created and saved depending on a user, even if they were based on a same scenario content. These differences in configuration may impair comparability and reliability of simulation results that were run under identical conditions. Accordingly, it may be necessary to derive a process capable of generating a virtual scenario in a structurally consistent manner based on a central event of the scenario and a method of setting actions according to a state of each participating object.

The matters described in this Background section are only for enhancement of understanding of the background of the disclosure, and should not be taken as acknowledgement that they correspond to prior art already known to those skilled in the art.

### SUMMARY

The present disclosure attempts to provide a method and apparatus for generating a virtual scenario capable of providing a process for generating a structurally consistent virtual scenario based on a central event of the scenario, a state of each participating object, and an action setting method.

According to one or more example embodiments of the present disclosure, a method, performed by an apparatus including a processor and a memory, may include: determining, by the processor, a virtual object participating in an event of a virtual scenario in a vehicle driving simulation for verifying a vehicle function; determining, by the processor and based on an event configuration of the virtual scenario for at least one vehicle, a trigger condition for synchronizing an action of the virtual object; identifying, by the processor, a state of the virtual object to determine a state-specific action for the state; identifying, by the processor, characteristics of a road environment of the virtual scenario and characteristics of a road environment-related object; obtaining, by the processor and based on the characteristics of the road environment and the characteristics of the road environment-related object, a trained road network model that includes the road environment and the road environment-related object; based on the virtual object, the trigger condition, the state-specific action, and the trained road network model, creating, by the processor, a virtual scenario file describing the virtual scenario according to a predetermined schema associated with the virtual scenario; and causing, based on the virtual scenario file, an update of at least one of the vehicle driving simulation or autonomous driving of the at least one vehicle.

Determining the virtual object may include: determining, by the processor, a target vehicle to be evaluated as the virtual object; and determining, by the processor, specifications for the target vehicle to be evaluated.

Determining the virtual object may include: determining, by the processor, another vehicle, different from a target vehicle to be evaluated, as the virtual object; and determining, by the processor, specifications for the another vehicle.

The another vehicle may include at least one of an opposing vehicle, a bicycle, or an obstacle vehicle.

Determining the virtual object may include: determining, by the processor, a pedestrian as the virtual object.

The event in the virtual scenario may include a plurality of events. Determining the trigger condition may include determining, by the processor, a plurality of trigger conditions, each trigger condition of the plurality of trigger conditions corresponding to a different event of the plurality of events. The plurality of trigger conditions may include a simulation time reference condition, a connectivity condition between events, and a connectivity condition with another virtual object.

The identified state of the virtual object may be an initial state. The state-specific action of the initial state may include at least one of: moving the virtual object to a position specified at a start of the vehicle driving simulation, moving the virtual object in a longitudinal direction, or moving the virtual object in a transverse direction.

The identified state of the virtual object may be a transition state. The state-specific action of the transition state may include moving the virtual object according to a test condition.

The identified state of the virtual object may be a default state. The state-specific action of the default state may include maintaining a condition of a previous state as a state immediately before result observation.

The method may further include: determining, by the processor, a type of contents related to the virtual scenario among a first content type including contents for international regulatory certification and evaluation of autonomous driving functions, a second content type including contents for reproducing historical auto accidents, and a third content type including contents related to test cases for evaluation of autonomous driving functions.

According to one or more example embodiments of the present disclosure, an apparatus may include a processor and a memory. The memory may store at least one instruction that is configured, when executed by the processor, to cause the apparatus to: determine a virtual object that participates in an event of a virtual scenario in a vehicle driving simulation for verifying a vehicle function; determine, based on an event configuration of the virtual scenario for at least one vehicle, a trigger condition for synchronizing an action of the virtual object; identify a state of the virtual object to determine a state-specific action for the state; identify characteristics of a road environment of the virtual scenario and characteristics of a road environment-related object; obtain, based on the characteristics of the road environment and the characteristics of the road environment-related object, a trained road network model that includes the road environment and the road environment-related object; based on the virtual object, the trigger condition, the state-specific action, and the trained road network model, create a virtual scenario file describing the virtual scenario according to a predetermined schema associated with the virtual scenario; and cause, based on the virtual scenario file, an update of at least one of the vehicle driving simulation or autonomous driving of the at least one vehicle.

The at least one instruction may be configured, when executed by the processor, to cause the apparatus to determine the virtual object by: determining a target vehicle to be evaluated as the virtual object; and determining specifications for the target vehicle to be evaluated.

The at least one instruction may be configured, when executed by the processor, to cause the apparatus to determine the virtual object by: determining another vehicle, different from a target vehicle to be evaluated, as the virtual object; and determining specifications for the another vehicle.

The another vehicle may include at least one of an opposing vehicle, a bicycle, or an obstacle vehicle.

The at least one instruction may be configured, when executed by the processor, to cause the apparatus to determine the virtual object by: determining a pedestrian as the virtual object.

The event in the virtual scenario includes a plurality of events. The at least one instruction may be configured, when executed by the processor, to cause the apparatus to determine the trigger condition by: determining a plurality of trigger conditions, each trigger condition of the plurality of trigger conditions corresponding to a different event of the plurality of events. The plurality of trigger conditions may include a simulation time reference condition, a connectivity condition between events, and a connectivity condition with another virtual object.

The identified state of the virtual object may be an initial state. The state-specific action of the initial state may include at least one of: moving the virtual object to a position specified at a start of the vehicle driving simulation, moving the virtual object in a longitudinal direction, or moving the virtual object in a transverse direction.

The identified state of the virtual object may be a transition state. The state-specific action of the transition state may include moving the virtual object according to a test condition.

The identified state of the virtual object may be a default state. The state-specific action of the default state may include maintaining a condition of a previous state as a state immediately before result observation.

According to one or more example embodiments of the present disclosure, a computer-readable medium may store at least one instruction that is configured, when executable by an apparatus, to cause the apparatus to generate a virtual scenario, for a computer simulation of an autonomous driving operation of an autonomous vehicle, by: generating one or more dynamic virtual objects, in the virtual scenario, by determining, for each dynamic virtual object of the one or more dynamic virtual objects: a dynamic virtual object type including at least one of the autonomous vehicle, another vehicle, a pedestrian, or a bicycle, one or more dynamic virtual object properties including at least one of: a size, a position, a moving path, a velocity, an acceleration, or braking capability, a plurality of states including at least one of an initial state, a transition state, or a default state, and a plurality of actions including at least one of an initiate-state action, a transition-state action, or a default-state action; and generating one or more static virtual objects, in the virtual scenario, by determining, for each static virtual object of the one or more static virtual objects: a static virtual object type including at least one of a traffic light or a traffic sign, and a static virtual object bounding box. The at least one instruction may be further configured, when executable by an apparatus, to perform the computer simulation on the generated virtual scenario; and cause, based on a result of the computer simulation, the autonomous driving operation of the autonomous vehicle.

### BRIEF DESCRIPTION OF THE DRAWINGS

FIG. 1 is a block diagram showing example components of a virtual scenario generation apparatus.

FIG. 2 is a flow diagram for an example virtual scenario generation method.

FIGS. 3A and 3B are block diagrams showing some example components and an example format of a virtual scenario.

FIG. 4 shows an example user interface of a virtual scenario generation apparatus.

FIG. 5 is a block diagram showing example virtual objects participating in an event of a virtual scenario.

FIG. 6 is a diagram showing specifications being determined for a vehicle among virtual objects participating in an event of a virtual scenario.

FIG. 7 shows an example user interface of the virtual scenario generation apparatus for receiving an input from a user of values necessary for determining virtual objects participating in an event of a virtual scenario or for determining specifications for the virtual objects.

FIGS. 8A and 8B are flow diagrams showing example trigger conditions for synchronizing an action of a virtual object.

FIG. 9 is a diagram showing an example action for each state of a virtual object determined by a virtual object action setting module.

FIG. 10 shows an example user interface of the virtual scenario generation apparatus for receiving an input from a user of values necessary for determining state-specific actions.

FIG. 11 shows an example configuration of a road network model.

FIGS. 12 and 13 show an example user interface of the virtual scenario generation apparatus for obtaining a road network model on a display device.

FIG. 14 is a view of an example computing device.

### DETAILED DESCRIPTION

Hereinafter, the present disclosure will be described more fully with reference to the accompanying drawings, in which one or more example embodiments of the disclosure are shown. As those skilled in the art would realize, the described example embodiment(s) may be modified in various different ways, all without departing from the spirit or scope of the present disclosure. Accordingly, the drawings and description are to be regarded as illustrative in nature and not restrictive. Like reference numerals designate like elements throughout the specification.

In addition, throughout the specification and claims, unless explicitly described to the contrary, the word “comprise” and variations such as “comprises” or “comprising” will be understood to imply the inclusion of stated elements but not the exclusion of any other elements. Terms including ordinal numbers such as first, second, and the like will be used only to describe various components, and are not to be interpreted as limiting these components. The terms are only used to differentiate one component from other components.

Terms such as “part,” “portion,” “module,” etc., described in the specification may indicate a unit capable of processing at least one function or operation described in the specification, and this may be implemented by hardware or a circuit, software, or a combination of hardware or a circuit and software. Furthermore, at least some of the components or functions of the virtual scenario generation method and apparatus based on model profiling according to the example embodiment(s) described below may be implemented as a program or software, and the program or software may be stored in a computer-readable recording medium or storage medium.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The term “unit” as used herein may refer to software, or hardware component such as Field-Programmable Gate Array (FPGA), Application Specific Integrated Circuit (ASIC), etc. However, “unit” is not limited to hardware and software. The “unit" may be configured to be stored in an addressable storage medium, or may be configured to execute one or more processors. The "unit" may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based” on as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

A vehicle (also referred to as a mobility apparatus or a mobility device) may be any apparatus or device capable of movement. A vehicle may be capable of movement by means of self-propulsion using, for example, one or more motors or engines. A vehicle may be capable of traversing over and/or across different terrains and spaces, such as land, underground, air, space, sea, and/or underwater. Land or underground vehicle may be provided, for example, in the form of automobiles, cars, trucks, buses, motorcycles, mopeds, bicycles, mobility scooters, robots, etc. Air or space vehicles may be provided, for example, in the form of air mobility apparatuses, such as fixed-wing or rotary-wing aircraft, advanced air mobility (AAM) devices, unmanned aerial vehicles, drones, rockets, or vehicles mounted on satellites. Marine or underwater vehicles may include, for example, ships, boats, jet skis, hovercraft, submarines, etc. A vehicle may move across multiple terrains or spaces.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., determining ana analyzing one or more virtual objects participating in an event of a virtual scenario) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., determining ana analyzing one or more virtual objects participating in an event of a virtual scenario) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., determining ana analyzing one or more virtual objects participating in an event of a virtual scenario) described herein.

Minimum risk maneuver (MRM) operation(s) may also be controlled, for example, based on one or more features (e.g., determining ana analyzing one or more virtual objects participating in an event of a virtual scenario) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., determining ana analyzing one or more virtual objects participating in an event of a virtual scenario) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., determining ana analyzing one or more virtual objects participating in an event of a virtual scenario) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as 5 seconds, 30 seconds, 1 minute, etc.). By changing the required user attentiveness, the driver may be required to look ahead more often (e.g., at least once in a threshold time period, such as 5 seconds, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., determining ana analyzing one or more virtual objects participating in an event of a virtual scenario) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), engaging and/or disengaging an autonomous driving mode, etc.). One or more auxiliary devices (e.g., engine brake, exhaust brake, hydraulic retarder, electric retarder, regenerative brake, etc.) may also be controlled, for example, based on one or more features (e.g., determining ana analyzing one or more virtual objects participating in an event of a virtual scenario) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., evaluating the engagement state of the driver) described herein. For example, after running (e.g., executing) one or more iterations of a computer simulation of a virtual scenario that is generated by utilizing one or more example embodiments of the present disclosure, an autonomous driving operation logic of an autonomous vehicle may be programmed and/or adjusted. In other words, one or more autonomous operations of the vehicle may be performed based on the outcome (e.g., results) of simulating the virtual scenario, which may include one or more virtual objects.

The vehicle that an autonomous driving system is actively controlling may be referred to as an ego vehicle, a host vehicle, or an autonomous vehicle. The ego vehicle may also be referred to as a self-driving car, an autonomous car (AC), a driverless car, a robotaxi, a robotic car, or a robo-car. The ego vehicle may be the vehicle that is equipped with the autonomous driving system. Alternatively, the autonomous driving system may control the ego vehicle, for example, from an external and/or remote device, such as a server. The ego vehicle can be partially or wholly controlled (e.g., piloted, driven, etc.) remotely by a remote human driver. A car that is ahead of the ego vehicle (e.g., in the same driving lane as the ego vehicle) may be referred to as a vehicle in front (e.g., a vehicle directly in front), a vehicle ahead (e.g., a vehicle directly ahead), a lead vehicle, a leading vehicle, or a preceding vehicle. A car that follows the ego vehicle (e.g., in the same driving lane as the ego vehicle) may be referred to as a car behind, a trailing vehicle, a following vehicle, or a succeeding vehicle. An adjacent vehicle may refer to any vehicle located in any direction (e.g., front, rear, left, right, diagonal, etc.) from the ego vehicle as long as no other vehicles (e.g., intervening vehicles) exist between it and the ego vehicle (e.g., regardless of the distance from the ego vehicle). Alternatively, in some contexts, only those vehicles that are located within a threshold distance (e.g., line of sight and/or detection limit of one or more sensors of the ego vehicle) from the ego vehicle may be referred to as adjacent vehicles. A target vehicle may be any vehicle that is near the ego vehicle (e.g., within a threshold distance away from the ego vehicle). The target vehicle may be any vehicle that the autonomous driving system monitors, recognizes, identifies, tracks, and/or analyzes, either actively or passively, either once or multiple times, and either sporadically or continuously. The threshold distance may be, for example, the line of sight and/or the detection limit of one or more sensors of the ego vehicle, but the threshold distance may be a value (e.g., an adjustable value) that is less than the line of sight and/or the detection limit of the one or more sensors of the ego vehicle. The target vehicle can be, for example, a vehicle in front, a vehicle behind, a vehicle in a different lane than the driving lane of the ego vehicle (e.g., a vehicle to the left, a vehicle to the right, a vehicle in a diagonal direction, etc.), and/or an adjacent vehicle (e.g., regardless of the distance from the ego vehicle and/or regardless of whether there are intervening vehicle(s) between the target vehicle and the ego vehicle). A target vehicle may also be referred to as a surrounding vehicle, a nearby vehicle, an external vehicle, another vehicle (other vehicles), and so forth.

In the context of a virtual scenario in a computer simulation, however, a “target vehicle” may also refer to an ego vehicle that is capable of autonomous driving functionalities and/or is controlled by an autonomous driving system. In other words, the “target vehicle” may be the vehicle for which the computer simulation is being performed to analyze one or more virtual scenarios.

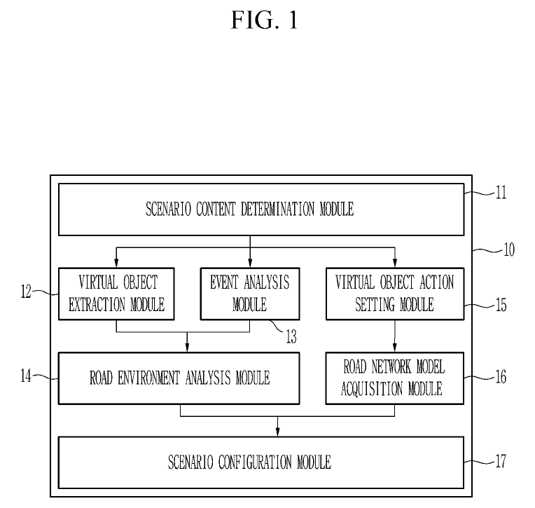

FIG. 1 is a block diagram showing example components of a virtual scenario generation apparatus.

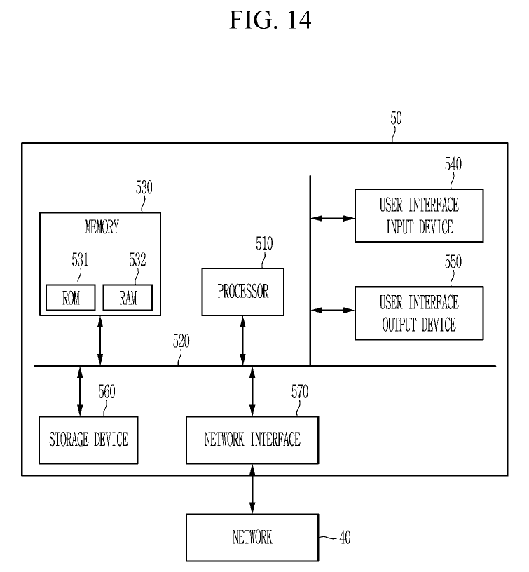

Referring to FIG. 1, the virtual scenario generation apparatus 10 may be implemented as a computing device including a processor and a memory. For example, the virtual scenario generation apparatus 10 may be implemented as a computing device 50 as described below with reference to FIG. 14. In this case, the processor may correspond to a processor 510 of the computing device 50, and the memory may correspond to a memory 520 of the computing device 50. Alternatively, the virtual scenario generation apparatus 10 may include one or more non-transitory computer-readable media including instructions and one or more processors for executing the instructions to perform operations. Herein, the operations may include a configuration, a function, a step, etc. described in this specification with respect to the virtual scenario generation method and apparatus according to the example embodiment(s). In this specification, the term "module" is used to logically distinguish these operations performed by the virtual scenario generation method and apparatus according to the example embodiment(s).

The virtual scenario generation apparatus 10 may include a scenario content determination module 11, a virtual object extraction module 12, an event analysis module 13, a virtual object action setting module 14, a road environment analysis module 15, a road network model acquisition module 16, and a scenario configuration module 17.

The scenario content determination module 11 may determine a type of contents related to a virtual scenario among contents for international regulatory certification and evaluation of autonomous driving functions, contents for reproducing actual collision accidents, and contents related to test cases for evaluation of autonomous driving functions. That is, the scenario content determination module 11 may perform a function of selecting test or evaluation items for generating a virtual scenario, and may determine a simulation target content based on a test protocol proposed in international laws and certification evaluation of an autonomous driving function, reproduction of an actual accident case (e.g., a historical auto accident), a test case for autonomous driving function evaluation, etc.

The scenario content determination module 11 may determine, e.g., a car to pedestrian near-side children obstructed (CPNCO) scenario among the EuroNCAP test protocols (autonomous emergency braking (ABE)) as a target content. The scenario content may concern a situation where a child pedestrian enters a roadway while a view thereof is restricted by an obstacle on a side of a moving direction of a moving vehicle. As another example, the scenario content determination module 11 may determine a EuroNCAP car-to-bicyclist nearside adult obstructed (CBNAO) scenario as the target content. The scenario content may concern a situation where an adult cyclist enters a road from behind an obstacle that obstructs visibility, on a side of a moving vehicle.

The virtual object extraction module 12 may determine a virtual object participating in an event of a virtual scenario. The virtual object extraction module 12 may determine an object type, such as a dynamic object or a static object. Specifically, the virtual object extraction module 12 may define a dynamic object such as a vehicle, a pedestrian, or a bicycle as a virtual object (e.g., virtual object type) that operates in an event within a virtual scenario, and may extract an object that participate in an event within a scenario content selected by the scenario content determination module 11. For example, if simulation verification targets an event that may occur between a vehicle and a pedestrian or between vehicles, the virtual object extraction module 12 may determine the vehicle and the pedestrian as main objects. Meanwhile, the virtual object extraction module 12 may declare a vehicle that acts as an obstacle (e.g., a vehicle parked on a road) as a vehicle object with a velocity of 0.

The virtual object extraction module 12 may define a static object, such as a traffic light and a traffic sign existing on a road, in a virtual road file. For the traffic light, an object itself may be defined within a virtual road, whereas a phase of the traffic light and control information may be defined within a virtual scenario. Meanwhile, a size of each object (e.g., size based on a bounding box) and specifications (e.g., dimensions, materials, weight, horsepower, etc.) such as major coordinates may be defined in the scenario file, and a shape file of the object used in the simulation may be referenced externally.

The virtual object extraction module 12 may determine a target vehicle to be evaluated as a virtual object participating in an event, and may determine specifications (e.g., dimensions, materials, weight, horsepower, etc.) for a target vehicle to be evaluated. For example, the target vehicle may be the ego vehicle having the autonomous driving capabilities. In this case, the target vehicle to be evaluated may be a vehicle equipped with an autonomous driving function or an advanced driver assistance systems (ADAS), and the virtual object extraction module 12 may define detailed specifications of the vehicle, such as its size, initial position, moving path (e.g., driving path), velocity, acceleration, and braking capability, within a scenario file.

The virtual object extraction module 12 may determine another vehicle, that is distinct from the target vehicle (e.g., ego vehicle) to be evaluated, as a virtual object participating in the event, and may determine specifications of the another vehicle. Herein, the another vehicle may include at least one of an opposing vehicle, a bicycle, or an obstacle vehicle. For example, the another vehicle may be any other vehicle (e.g., in the surrounding environment of the ego vehicle) that may be considered a target vehicle from the perspective of the ego vehicle. Herein, the opposing vehicle may refer to a vehicle traveling in an opposite direction to the target vehicle to be evaluated (e.g., a vehicle that is approaching from the opposite direction or having an opposite direction of travel as the target vehicle), and the bicycle may be defined as a dynamic object moving independently on a road. An obstacle vehicle may be a vehicle that is in a fixed (e.g., stationary) position or is exhibiting limited motion, for example, a vehicle parked on a road. The virtual object extraction module 12 may define specifications, such as velocity, size, initial position, and operation method, for each of these virtual objects in a scenario file.

The virtual object extraction module 12 may determine a pedestrian as a virtual object participating in an event. In this case, the pedestrian may be set as an object for evaluating perception and response capabilities of autonomous vehicle, according to various scenarios such as crossing a road, moving after stopping, and irregular entry. The virtual object extraction module 12 may also define size, movement velocity, starting position, and movement path of a pedestrian as specifications in the scenario file.

The event analysis module 13 may analyze event composition of a virtual scenario, and may set a trigger condition for synchronizing an action of a virtual object. Specifically, the event analysis module 13 may analyze a content of an event to be observed and a behavior of each virtual object within a scenario to define key actions, and may set a trigger condition for synchronizing an execution time of the actions.

An event of a virtual scenario may include multiple events, and the event analysis module 13 may set a trigger condition for each of the multiple events, including a simulation time reference condition, a connectivity condition between events, and a connectivity condition with another virtual object. Specifically, a scenario may contain one or more events, and each event may be formed of multiple actions and triggers. These events may be specific situations or phenomena defined by a user, and may occur sequentially or together. Details of an action may be defined based on absolute criteria, such as a specific time or a position, or based on a relationship, such as a distance or a velocity relative to a specific virtual object. The event analysis module 13 may configure a scenario such that multiple virtual objects is able to operate in a synchronized state by setting a trigger condition in consideration of factors such as a progress time of the simulation, a relationship between different events, or a status change of another virtual object.

The virtual object action setting module 14 may determine an action for each state by distinguishing (e.g., identifying) a state of a virtual object. Specifically, the virtual object action setting module 14 may divide (e.g., categorize, classify, etc.) a state of a virtual object in a scenario into three stages: an initial state, a transition state, and a normal state (e.g., default state), and may define an action of the virtual object corresponding to each state from start to an end point of an event.

The virtual object action setting module 14 may determine a state of the virtual object as an initial state, and may determine a state-specific action with respect to the initial state to include at least one of an action of moving the virtual object to a position specified at a start point of the simulation, an action of moving the virtual object in a longitudinal direction, and an action of moving the virtual object in a transverse direction. That is, in the initial state, the virtual object action setting module 14 may set the position of the virtual object at the start point of the simulation, and this position may be defined as simulation world reference coordinates, road or lane-based coordinates, a position within a specific path, etc. Additionally, in the initial state, the virtual object action setting module 14 may also set the longitudinal or transverse action to be performed by the virtual object.

The virtual object action setting module 14 may determine the state of the virtual object to be a transition state, and may determine a state-specific action related to the transition state to include an action of moving the virtual object according to a test condition. That is, in the transition state, an action of the virtual object may be performed to satisfy the test condition according to development of events within the scenario, and may include actions such as driving straight, turning at an intersection, and changing lanes.

The virtual object motion setting module 14 may determine the state of the object as the normal state (e.g., default state), and may determine a state-specific action for the normal state to include an action of maintaining conditions of the previous state as a state immediately before result observation. That is, the normal state may be a state immediately before observing a simulation result, the virtual object may maintain a conditions set in a previous operation, and system's control action, whether an alert is generated, and other responses may be reviewed at that time point.

The road environment analysis module 15 may analyze road environment and road environment-related objects of a virtual scenario (e.g., identify characteristics of a road environment of the virtual scenario and characteristics of a road environment-related object), and the road network model acquisition module 16 may acquire (e.g., obtain, generate, etc.) a road network model (e.g., based on the characteristics of the road environment and the characteristics of the road environment-related object) including the road environment and the road environment-related objects. Specifically, the road environment analysis module 15 may analyze basic road specifications such as road shape, lane information, and road standards of the scenario, and determine presence or absence of a static object (e.g., a traffic signal, etc.) included therein.

The road network model acquisition module 16 may create (e.g., generate) a virtual road model file for a simulation or acquire it from outside, and for example, a road file in a format created according to an ASAM OpenDRIVE standard may be used. The road network model acquisition module 16 may identify a basic shape of a road (e.g., straight section, intersection, etc.) and, if necessary, may add a traffic signal object separately to a road model. For example, the road network model acquisition module 16 may set a single road structure in a case of a straight road configuration, and in this case, it may adjust a section length by considering a vehicle acceleration section, etc., and may set specifications such as a road width according to regulations to be applied in the simulation. The road network model acquisition module 16 may design a turning path based on straight road connection for intersection configuration such that the turning path matches a road center and a coordinate system, and may assign a unique ID to each connecting road. In addition, for a scenario including a traffic signal, the road network model acquisition module 16 may be configured in a way that a traffic signal object is loaded within a road model file, and a phase and state of a corresponding traffic signal may be defined within the virtual scenario.

The scenario configuration module 17 may create (e.g., , based on a virtual object, a trigger condition, a state-specific action, and a road network model) a virtual scenario file describing a virtual scenario according to a predetermined schema. For example, the scenario configuration module 17 may create a virtual scenario file according to the UML-based XML schema proposed by the ASAM OpenSCENARIO standard, and may specify a road network file path and a file name together within the scenario file. The generated virtual scenario may include static and dynamic elements. The static element may include general information about the scenario file, user-defined parameters, referenced road files, object declarations, etc. The dynamic element may serve as a component that controls progression of events within a scenario, and may be structured in a hierarchical format, with <Storyboard> as a top-level layer, followed by <Story>, <Act>, <Maneuver>, <Event>, and <Action>. A scenario file may contain only one <Storyboard>, and the <Storyboard> may define a simulation's termination condition using a stop trigger. In addition, the <Act> may control start and end of a specific action flow using start or stop triggers, while the start trigger of <Event> may be used as a condition to determine an occurrence timing of an event within the scenario. In this way, an overall flow of the scenario may be structured and expressed such that objects in the simulation may perform synchronized actions.

For example, the scenario content determination module 11 may determine a CPNCO scenario among EuroNCAP test protocols (AEB) as a target content. This scenario may involve a test vehicle driving along a straight driving path, detecting a pedestrian target emerging from between obstacles, and verifying whether an automatic emergency braking (AEB) function operates correctly. Specifically, a situation may be configured where two obstacle targets Target1 and Target2 are parked side by side on a right side of the road, a pedestrian enters in a direction of crossing the road from a position in front of Target1, and the test vehicle may detect appearance of the pedestrian in this situation and evaluate whether the AEB system responds appropriately to such a threat. Such a scenario may be repeatedly executed by changing a driving velocity of the test vehicle to, for example, 10 km/h, 20 km/h, 30 km/h, 40 km/h, 45 km/h, and 50 km/h to verify the AEB detection and response performance at each velocity condition.

The virtual object extraction module 12 may extract vehicle and pedestrian targets as virtual objects participating in events of a virtual scenario, and the event analysis module 13 may define a configuration of events within a simulation by setting action and trigger conditions of each virtual object. Specifically, the test vehicle may be set to perform a straight driving motion within the same lane, and the action may be configured based on a target velocity and an acceleration profile considering physical characteristics of an actual vehicle. Meanwhile, the pedestrian target may be defined to move along a straight path to a specific point in a direction of crossing the road from outside the lane, and it is an object that does not exist on the road or lane, so the path may be set based on the coordinate system within the simulation environment. In addition, the velocity of the test vehicle may change according to the scenario condition, but the goal may be to keep an overall simulation time the same, so the event analysis module 13 may configure a trigger condition based on the simulation time and appropriately adjust a longitudinal position of the pedestrian target according to a change in the velocity of the test vehicle to maintain a synchronized scenario flow.

The virtual object action setting module 14 may set an action according to a state of each virtual object. Specifically, the virtual object action setting module 14 may define the action of the virtual object by dividing it into an initial state, a transition state, and a normal state for a test vehicle, a pedestrian target, and a vehicle obstacle target.

For example, in a case of the test vehicle, in the initial state, it may be set to be teleported to a specific point on the road environment, the target velocity may be set to 0, in the transition state, it may be set to reach the target velocity through constant acceleration motion, and in the steady state, it may be set to maintain straight driving at the target velocity. For the pedestrian target, in the initial state, it may be teleported to a specific point within the road environment based on the velocity and position of the test vehicle, and the target velocity may be set to 0, and in the transition state, it may move along a predefined path over time, and in this case, the path may be set from a -y direction to a +y direction with respect to the test vehicle, and in the steady state, it may be set to continue moving along the set path. For vehicle obstacle targets Target1 and Target2, the test vehicle may be teleported to a specific point on the road environment based on the velocity and position of the test vehicle in the initial state, and the target velocity may be set to 0 and maintained in a stationary state.

The road environment analysis module 15 may analyze the road environment to be applied in a virtual scenario. Specifically, the road environment analysis module 15 may analyze a road shape for straight driving of the test vehicle, and a road applied at this time may be formed as a straight section. Additionally, a lane width on the road may be set to 3.5 meters, which may reflect actual road standard dimensions. Meanwhile, the road network model acquisition module 16 may create a road network model to be used in a simulation based on a road environment analysis result or acquire it from outside. Specifically, the road network model acquisition module 16 may generate a straight line road model including four lanes.

The scenario configuration module 17 may configure a virtual scenario based on a result of the entire process and write it as a scenario file based on a structure of an ASAM OpenSCENARIO standard format. The scenario file generated at this time may include information such as a virtual object, a trigger condition, a state-specific action, and a road network model, and may be structured according to a standardized XML schema.

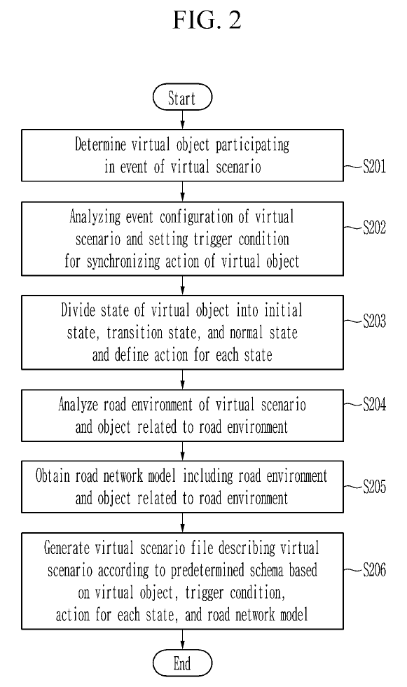

FIG. 2 is a flow diagram for an example virtual scenario generation method.

Referring to FIG. 2, a method for generating a virtual scenario may include an operation of determining a virtual object participating in an event of a virtual scenario (S201), an operation of analyzing an event configuration of the virtual scenario and setting a trigger condition for synchronizing an action of the virtual object (S202), an operation of dividing a state of the virtual object into an initial state, a transition state, and a normal state and defining an action for each state (S203), an operation of analyzing a road environment of the virtual scenario and an object related to the road environment (S204), an operation of obtaining a road network model including the road environment and the object related to the road environment (S205), and an operation of generating a virtual scenario file describing the virtual scenario according to a predetermined schema based on the virtual object, the trigger condition, the action for each state, and the road network model (S206).

For more detailed information related to the above method, a reference may be made to the description of another example embodiment included in this specification, so a redundant description will be omitted.

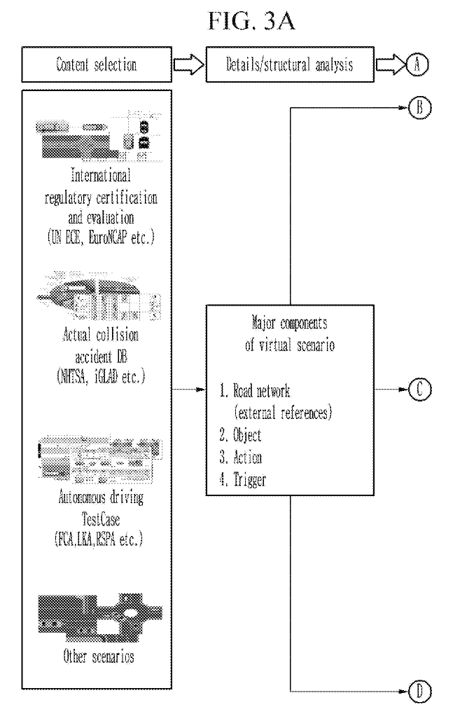

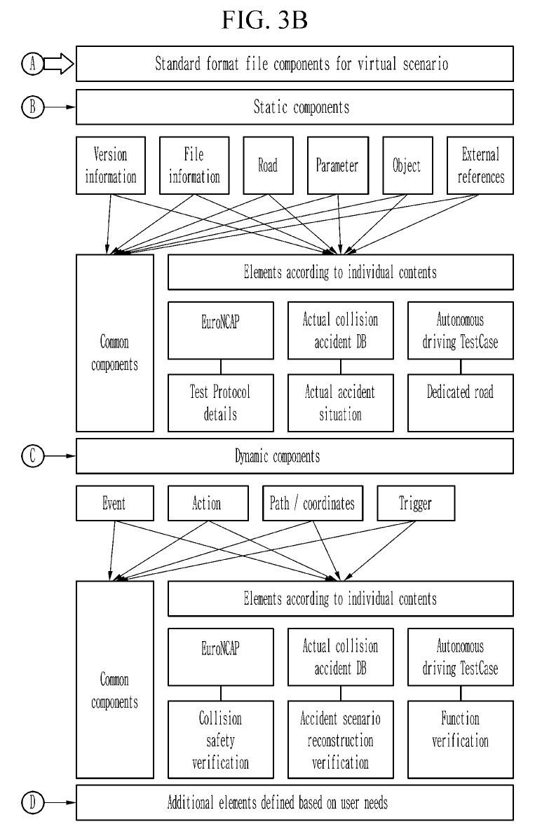

FIGS. 3A, 3B, 4-7, 8A, 8B, and 9-13 illustrate views for describing implementation examples related to a virtual scenario generation method.

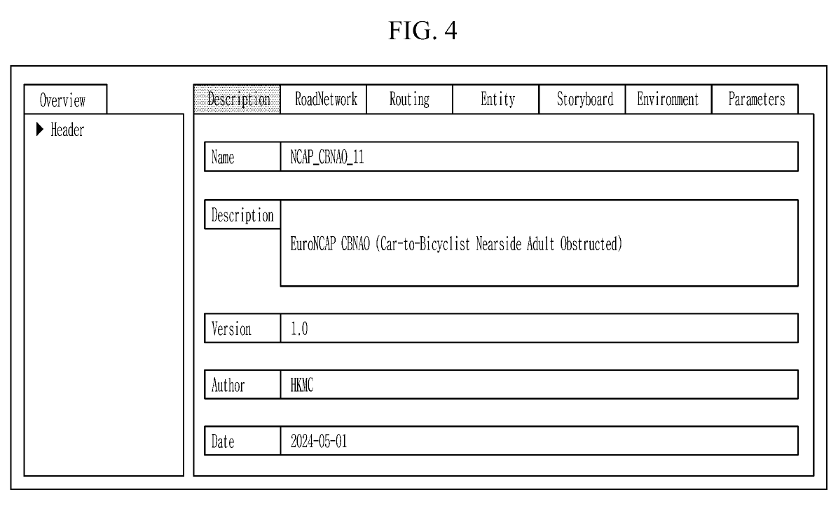

Referring to FIGS. 3A and FIG. 3B, according to a standard format of a virtual scenario, components of the scenario may be divided into static and dynamic elements, and the static and dynamic elements may include, in detail, common components and elements according to individual contents. Additionally, additional components may be defined depending on characteristics of the scenario that a user wishes to implement. FIG. 4 shows an example user interface of a virtual scenario generation apparatus. The virtual scenario generation apparatus may display a user interface on a display device for receiving an input from a user of values necessary for determining a simulation target content.

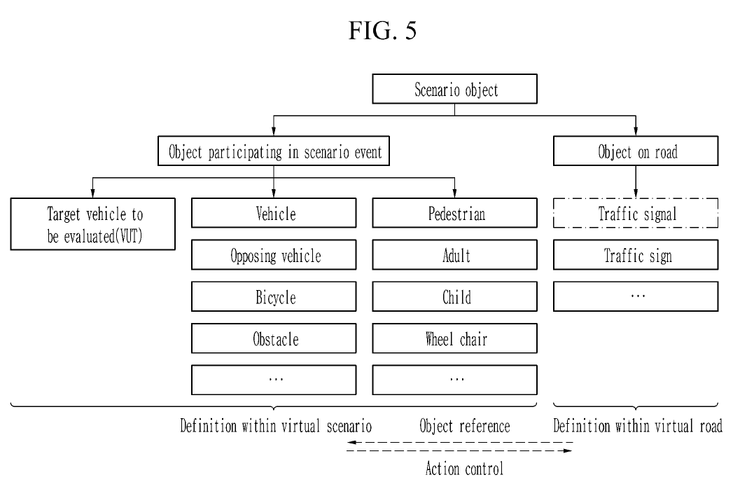

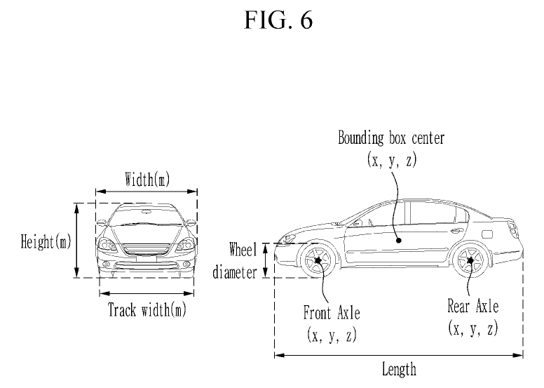

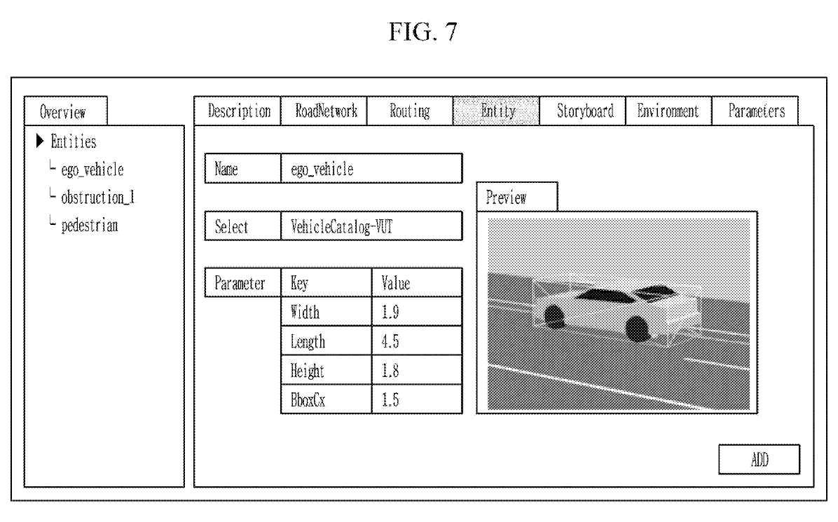

FIG. 5is a block diagram showing example virtual objects participating in an event of a virtual scenario, for example, as determined by the virtual object extraction module 12. FIG. 6 is a diagram showing specifications being determined for a vehicle among virtual objects participating in an event of a virtual scenario. FIG. 7 shows an example user interface of the virtual scenario generation apparatus for receiving an input from a user of values necessary for determining virtual objects participating in an event of a virtual scenario or for determining specifications for the virtual objects. The virtual scenario generation apparatus may display the user interface on a display device.

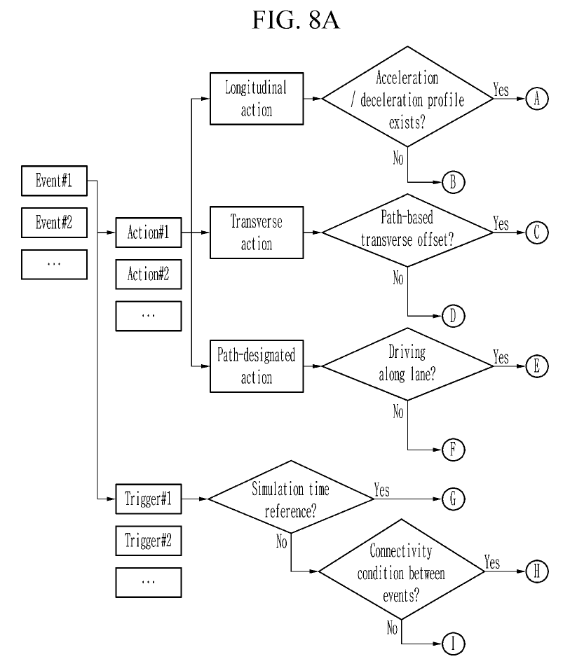

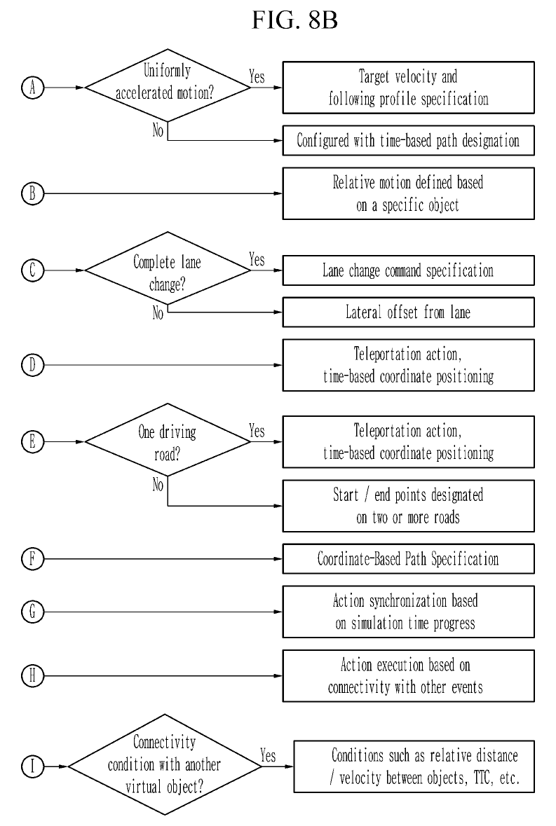

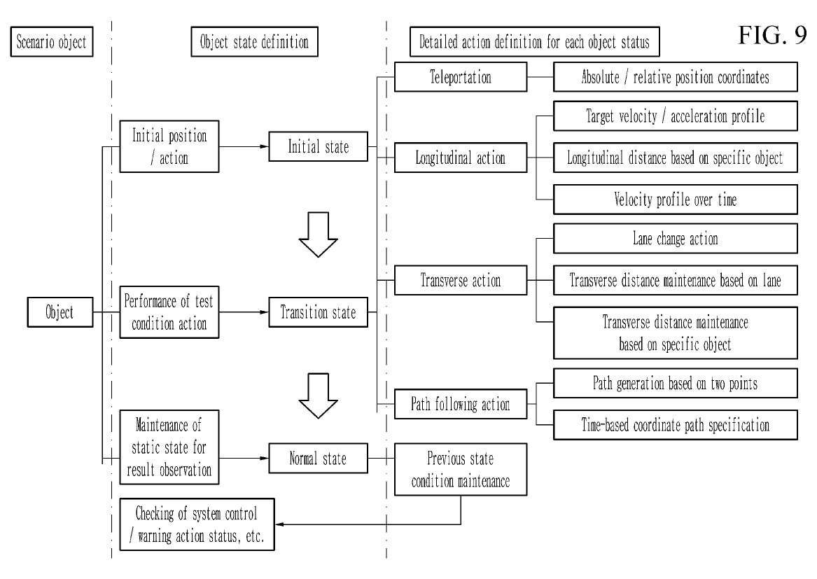

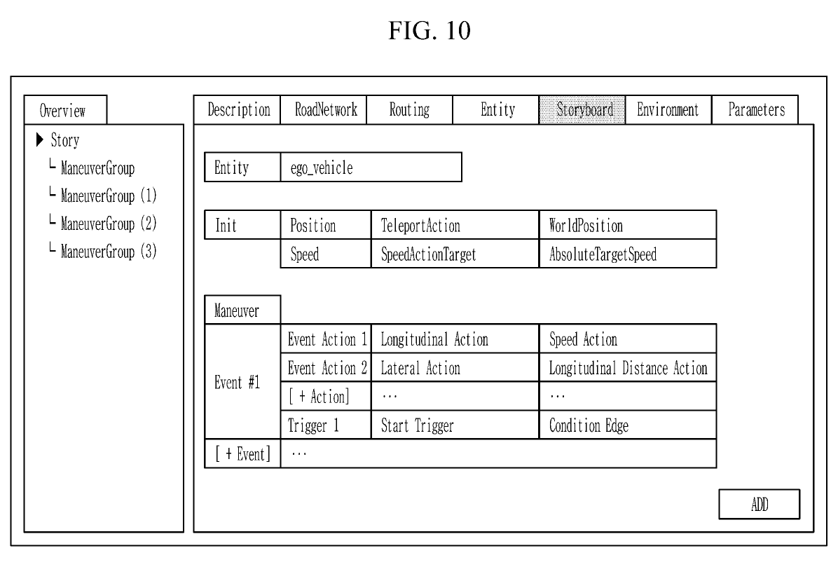

FIGS. 8A and 8B are flow diagrams showing example trigger conditions for synchronizing an action of a virtual object. The trigger conditions may be set by the event analysis module 13. FIG. 9 is a diagram showing an example action for each state of a virtual object determined by the virtual object action setting module 14. FIG. 10 shows an example user interface of the virtual scenario generation apparatus for receiving an input from a user of values necessary for determining state-specific actions. The user interface may displayed on a display device of the virtual scenario generation apparatus.

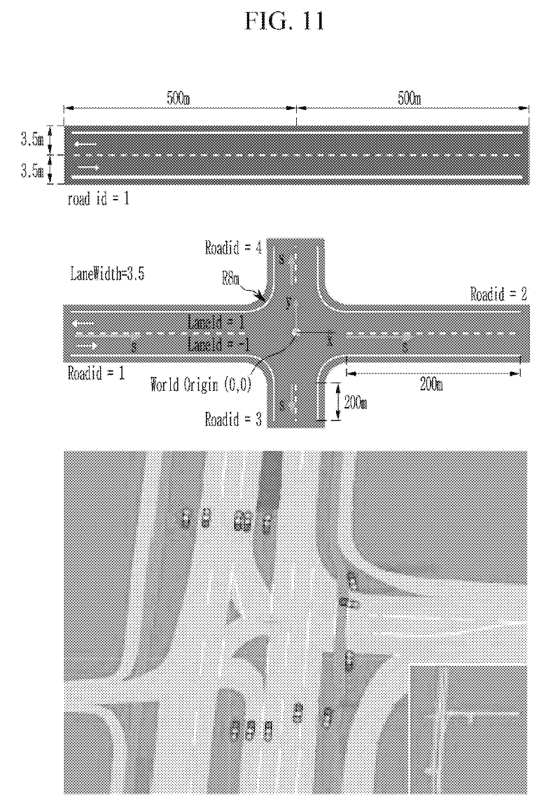

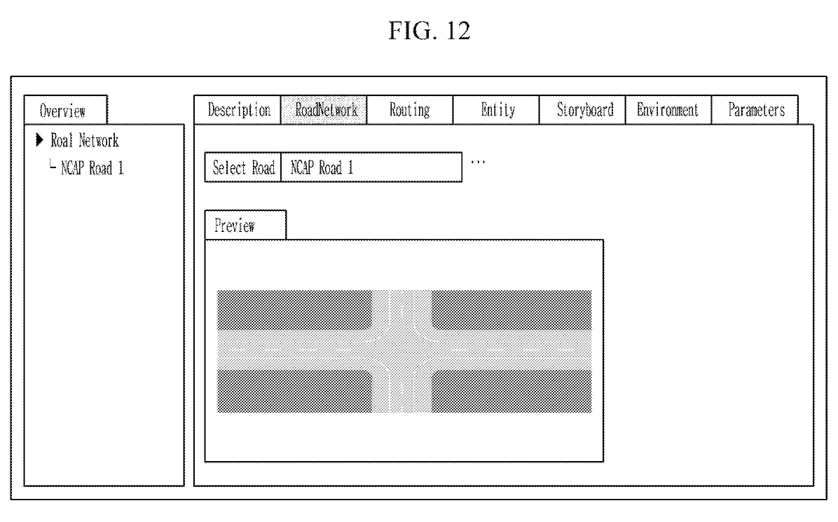

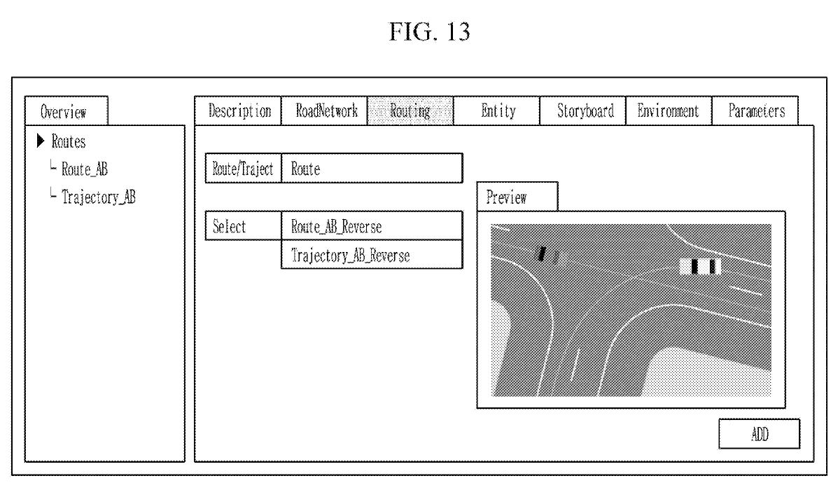

FIG. 11 shows an example configuration of a road network model. FIGS. 12 and 13 show an example user interface of the virtual scenario generation apparatus for obtaining a road network model on a display device.

FIG. 14 is a view of an example computing device.

Referring to FIG. 14, the virtual scenario generation method and apparatus may be implemented using the computing device 50. The computing device 50 may be implemented as various forms of electronic devices, servers, or similar devices, and their functions may be implemented through a combination of software and hardware.

The computing device 50 may include at least one of a processor 510, a memory 530, a user interface input device 540, a user interface output device 550, and a storage device 560 which communicate each other via a bus 520. The computing device 50 may also include a network interface 570 electrically connected to a network 40. The network interface 570 may transmit or receive signals to or from other virtual elements through the network 40.

The processor 510 may be implemented as various types of computational devices, such as a micro controller unit (MCU), an application processor (AP), a central processing unit (CPU), a graphic processing unit (GPU), a neural processing unit (NPU), a quantum processing unit (QPU), etc. The processor 510 may be a semiconductor device that executes instructions stored in a memory 530 or a storage device 560, and may play a key role in the system. Program codes and data stored in the memory 530 or the storage device 560 may instruct the processor 510 to perform specific tasks, thereby enabling a general operation of the system. The processor 510 may be configured to implement various functions and methods described above with respect to FIGS. 1-2, 3A, 3B, 4-7, 8A, 8B, and 9-13.

The memory 530 and the storage device 560 may include various forms of volatile or non-volatile storage media for storing and accessing data of the system. For example, the memory 530 may include a read only memory (ROM) 531 and a random access memory (RAM) 532. The memory 530 may be embedded within the processor 510, in which case a data transmission speed between the memory 530 and the processor 510 may be extremely fast. The memory 530 may be positioned external to the processor 510, in which case the memory 530 may be connected to the processor 510 via various data buses or interfaces. This connection may be made through a variety of already known means (e.g., a peripheral component interconnect express (PCIe) interface for high-speed data transfer or through a memory controller).

At least some of the components or functions of the virtual scenario generation method and apparatus may be implemented as a program or software running on the computing device 50, and the program or software may be stored on a computer-readable recording medium or storage medium. Specifically, a computer-readable recording medium or storage medium may be a program recorded on a computer including the processor 510 that executes a program or command stored in the memory 530 or the storage device 560 to execute operations included in the implementation of the virtual scenario generation method and apparatus based on model profiling.

At least some of the components or functions of the virtual scenario generation method and apparatus may be implemented using hardware or circuitry of the computing device 50, or may be implemented as separate hardware or circuitry that can be electrically connected to the computing device 50.

The computing device 50 may be provided with one or more non-transitory computer-readable media containing executable instructions, which, when executed by one or more processors of the computing device 50, cause the computing device 50 to perform operations. Herein, the operations may include a configuration, a function, a step, etc. described in this specification with respect to the virtual scenario generation method and apparatus.

According to one or more example embodiments of the present disclosure, a method for generating a virtual scenario used in a simulation for verifying a vehicle function may be performed by a computing device including a processor and a memory, the method including determining, by the processor, a virtual object participating in an event of the virtual scenario, analyzing, by the processor, an event configuration of the virtual scenario and setting a trigger condition for synchronizing an action of the virtual object, distinguishing, by the processor, a state of the virtual object to determine an action for each state, analyzing, by the processor, a road environment of the virtual scenario and a road environment-related object, obtaining, by the processor, a road network model including the road environment and the road environment-related object, and creating, by the processor, a virtual scenario file describing the virtual scenario according to a predetermined schema based on the virtual object, the trigger condition, the state-specific action, and the road network model.

The determining of the virtual object participating in the event may include determining, by the processor, a target vehicle to be evaluated as a virtual object participating in the event, and determining, by the processor, specifications for the target vehicle to be evaluated.

The determining of the virtual object participating in the event may further include determining, by the processor, another vehicle that is distinct from the target vehicle to be evaluated as the virtual object participating in the event, and determining, by the processor, specifications for the another vehicle.

The another vehicle may include at least one of an opposing vehicle, a bicycle, or an obstacle vehicle.

The determining of the virtual object participating in the event may include determining, by the processor, a pedestrian as the virtual object participating in the event.

The event in the virtual scenario may include multiple events, and the setting of the trigger condition may include setting, by the processor, a trigger condition for each of the multiple events, including a simulation time reference condition, a connectivity condition between events, and a connectivity condition with another virtual object.

The determining of the state-specific action may include determining, by the processor, the state of the virtual object as an initial state, and determining the state-specific action with respect to the initial state to include at least one of an action of moving the virtual object to a position specified at a start point of the simulation, an action of moving the virtual object in a longitudinal direction, and an action of moving the virtual object in a transverse direction.

The determining of the state-specific action may include determining, by the processor, the state of the virtual object as a transition state and determining the state-specific action regarding the transition state to include an action of moving the virtual object according to a test condition.

The determining of the state-specific action may include determining, by the processor, the state of the virtual object as a normal state and determining the state-specific action regarding the normal state to include an action of maintaining a condition of a previous state as a state immediately before result observation.

The method may further include determining, by the processor, a type of contents related to the virtual scenario among contents for international regulatory certification and evaluation of autonomous driving functions, contents for reproducing actual collision accidents, and contents related to test cases for evaluation of autonomous driving functions.

According to one or more example embodiments of the present disclosure, a virtual scenario generation apparatus may include one or more non-transitory computer-readable media containing instructions; and one or more processors configured to execute the instructions to perform an operation, wherein the operation may include determining a virtual object that participates in an event of the virtual scenario, analyzing an event configuration of the virtual scenario and setting a trigger condition for synchronizing an action of the virtual object, distinguishing a state of the virtual object to determine an action for each state, analyzing a road environment of the virtual scenario and a road environment-related object, obtaining a road network model including the road environment and the road environment-related object, and creating a virtual scenario file describing the virtual scenario according to a predetermined schema based on the virtual object, the trigger condition, the state-specific action, and the road network model.

The determining of the virtual object participating in the event may include determining a target vehicle to be evaluated as the virtual object participating in the event, and determining specifications for the target vehicle to be evaluated.

The determining of the virtual object participating in the event may further include determining another vehicle that is distinct from the target vehicle to be evaluated as the virtual object participating in the event, and determining specifications for the another vehicle.

The another vehicle may include at least one of an opposing vehicle, a bicycle, or an obstacle vehicle.

The determining of the virtual object participating in the event may further include determining a pedestrian as the virtual object participating in the event.

The event in the virtual scenario may include multiple events, and the setting of the trigger condition may include setting a trigger condition for each of the multiple events, including a simulation time reference condition, a connectivity condition between events, and a connectivity condition with another virtual object.

The determining of the state-specific action may include determining the state of the virtual object as an initial state, and determining the state-specific action with respect to the initial state to include at least one of an action of moving the virtual object to a position specified at a start point of the simulation, an action of moving the virtual object in a longitudinal direction, and an action of moving the virtual object in a transverse direction.

The determining of the state-specific action may include determining the state of the virtual object as a transition state and determining the state-specific action regarding the transition state to include an action of moving the virtual object according to a test condition.

The determining of the state-specific action may include determining the state of the virtual object as a normal state and determining the state-specific action regarding the normal state to include an action of maintaining a condition of a previous state as a state immediately before result observation.

According to one or more example embodiments of the present disclosure, a computer-readable medium may include one or more non-transitory computer-readable media containing instructions executable by a computing device, wherein the instructions, when executed by one or more processors of the computing device, cause the computing device to perform an operation, the operation including determining a virtual object that participates in an event of the virtual scenario, analyzing an event configuration of the virtual scenario and setting a trigger condition for synchronizing an action of the virtual object, distinguishing a state of the virtual object to determine an action for each state, analyzing a road environment of the virtual scenario and a road environment-related object, obtaining a road network model including the road environment and the road environment-related object, and creating a virtual scenario file describing the virtual scenario according to a predetermined schema based on the virtual object, the trigger condition, the state-specific action, and the road network model.

According to the example embodiment(s) of the present disclosure, as a virtual scenario is generated based on a central event of a scenario and an action setting method according to the state of each participating object, a structurally consistent scenario configuration may be possible, which not only may reduce a deviation in a scenario configuration between users may but also improve efficiency and reproducibility of simulation-based autonomous driving system verification by providing a standardized procedure for generating virtual scenarios.

While this disclosure is presented in connection with one or more example embodiments, it is to be understood that the present disclosure is not limited to the disclosed example embodiment(s), but, on the contrary, is intended to cover various modifications and equivalent arrangements included within the spirit and scope of the appended claims.

What is claimed is:

1. A method performed by an apparatus comprising a processor and a memory, the method comprising:
determining, by the processor, a virtual object participating in an event of a virtual scenario in a vehicle driving simulation for verifying a vehicle function;
determining, by the processor and based on an event configuration of the virtual scenario for at least one vehicle, a trigger condition for synchronizing an action of the virtual object;
identifying, by the processor, a state of the virtual object to determine a state-specific action for the state;
identifying, by the processor, characteristics of a road environment of the virtual scenario and characteristics of a road environment-related object;
obtaining, by the processor and based on the characteristics of the road environment and the characteristics of the road environment-related object, a trained road network model that comprises the road environment and the road environment-related object;
based on the virtual object, the trigger condition, the state-specific action, and the trained road network model, creating, by the processor, a virtual scenario file describing the virtual scenario according to a predetermined schema associated with the virtual scenario; and
causing, based on the virtual scenario file, an update of at least one of the vehicle driving simulation or autonomous driving of the at least one vehicle.

2. The method of claim 1, wherein the determining of the virtual object comprises:
determining, by the processor, a target vehicle to be evaluated as the virtual object; and
determining, by the processor, specifications for the target vehicle to be evaluated.

3. The method of claim 1, wherein the determining of the virtual object comprises:
determining, by the processor, another vehicle, different from a target vehicle to be evaluated, as the virtual object; and
determining, by the processor, specifications for the another vehicle.

4. The method of claim 3, wherein the another vehicle comprises at least one of an opposing vehicle, a bicycle, or an obstacle vehicle.

5. The method of claim 1, wherein the determining of the virtual object comprises:
determining, by the processor, a pedestrian as the virtual object.

6. The method of claim 1, wherein the event in the virtual scenario comprises a plurality of events, and
wherein the determining of the trigger condition comprises determining, by the processor, a plurality of trigger conditions, each trigger condition of the plurality of trigger conditions corresponding to a different event of the plurality of events, and
wherein the plurality of trigger conditions comprise a simulation time reference condition, a connectivity condition between events, and a connectivity condition with another virtual object.

7. The method of claim 1, wherein the identified state of the virtual object is an initial state, and
wherein the state-specific action of the initial state comprises at least one of: moving the virtual object to a position specified at a start of the vehicle driving simulation, moving the virtual object in a longitudinal direction, or moving the virtual object in a transverse direction.

8. The method of claim 1, wherein the identified state of the virtual object is a transition state, and
wherein the state-specific action of the transition state comprises moving the virtual object according to a test condition.

9. The method of claim 1, wherein the identified state of the virtual object is a default state, and
wherein the state-specific action of the default state comprises maintaining a condition of a previous state as a state immediately before result observation.

10. The method of claim 1, further comprising:
determining, by the processor, a type of contents related to the virtual scenario among a first content type comprising contents for international regulatory certification and evaluation of autonomous driving functions, a second content type comprising contents for reproducing historical auto accidents, and a third content type comprising contents related to test cases for evaluation of autonomous driving functions.

11. An apparatus comprising:
a processor; and
a memory storing at least one instruction that is configured, when executed by the processor, to cause the apparatus to:
determine a virtual object that participates in an event of a virtual scenario in a vehicle driving simulation for verifying a vehicle function;
determine, based on an event configuration of the virtual scenario for at least one vehicle, a trigger condition for synchronizing an action of the virtual object;
identify a state of the virtual object to determine a state-specific action for the state;
identify characteristics of a road environment of the virtual scenario and characteristics of a road environment-related object;
obtain, based on the characteristics of the road environment and the characteristics of the road environment-related object, a trained road network model that comprises the road environment and the road environment-related object;
based on the virtual object, the trigger condition, the state-specific action, and the trained road network model, create a virtual scenario file describing the virtual scenario according to a predetermined schema associated with the virtual scenario; and
cause, based on the virtual scenario file, an update of at least one of the vehicle driving simulation or autonomous driving of the at least one vehicle.

12. The apparatus of claim 11, wherein the at least one instruction is configured, when executed by the processor, to cause the apparatus to determine the virtual object by:
determining a target vehicle to be evaluated as the virtual object; and
determining specifications for the target vehicle to be evaluated.

13. The apparatus of claim 12, wherein the at least one instruction is configured, when executed by the processor, to cause the apparatus to determine the virtual object by:
determining another vehicle, different from a target vehicle to be evaluated, as the virtual object; and
determining specifications for the another vehicle.

14. The apparatus of claim 13, wherein the another vehicle comprises at least one of an opposing vehicle, a bicycle, or an obstacle vehicle.

15. The apparatus of claim 12, wherein the at least one instruction is configured, when executed by the processor, to cause the apparatus to determine the virtual object by:
determining a pedestrian as the virtual object.

16. The apparatus of claim 11, wherein the event in the virtual scenario comprises a plurality of events, and
wherein the at least one instruction is configured, when executed by the processor, to cause the apparatus to determine the trigger condition by:
determining a plurality of trigger conditions, each trigger condition of the plurality of trigger conditions corresponding to a different event of the plurality of events, and
wherein the plurality of trigger conditions comprise a simulation time reference condition, a connectivity condition between events, and a connectivity condition with another virtual object.

17. The apparatus of claim 11, wherein the identified state of the virtual object is an initial state, and
wherein the state-specific action of the initial state comprises at least one of: moving the virtual object to a position specified at a start of the vehicle driving simulation, moving the virtual object in a longitudinal direction, or moving the virtual object in a transverse direction.

18. The apparatus of claim 11, wherein the identified state of the virtual object is a transition state, and
wherein the state-specific action of the transition state comprises moving the virtual object according to a test condition.

19. The apparatus of claim 11, wherein the identified state of the virtual object is a default state, and
wherein the state-specific action of the default state comprises maintaining a condition of a previous state as a state immediately before result observation.

20. A computer-readable medium storing at least one instruction that is configured, when executable by an apparatus, to cause the apparatus to:
generate a virtual scenario, for a computer simulation of an autonomous driving operation of an autonomous vehicle, by:
generating one or more dynamic virtual objects, in the virtual scenario, by determining, for each dynamic virtual object of the one or more dynamic virtual objects:
a dynamic virtual object type comprising at least one of the autonomous vehicle, another vehicle, a pedestrian, or a bicycle,
one or more dynamic virtual object properties comprising at least one of: a size, a position, a moving path, a velocity, an acceleration, or braking capability,
a plurality of states comprising at least one of an initial state, a transition state, or a default state, and
a plurality of actions comprising at least one of an initiate-state action, a transition-state action, or a default-state action; and
generating one or more static virtual objects, in the virtual scenario, by determining, for each static virtual object of the one or more static virtual objects:
a static virtual object type comprising at least one of a traffic light or a traffic sign, and
a static virtual object bounding box;
perform the computer simulation on the generated virtual scenario; and
cause, based on a result of the computer simulation, the autonomous driving operation of the autonomous vehicle.
